(19) United States
(12) Patent Application Publication
(10) Pub. No.: US 2026/0365900 A1
(43) Pub. Date: Nov. 19, 2026

(54) Heat Transfer Composition and Heat Pump Including the Same

(71) Applicants: SK On Co., Ltd., Seoul (KR); SK Innovation Co., Ltd., Seoul (KR)

(72) Inventors: Ji Seong NOH, Daejeon (KR); Hyung Joo YIM, Daejeon (KR); Seul Hui CHOI, Daejeon (KR)

(21) Appl. No.: 19/677,043

(22) Filed: May 14, 2026

(30) Foreign Application Priority Data
May 16, 2025 (KR) 10-2025-0064127
Jan. 14, 2026 (KR) 10-2026-0007381

(51) Int. Cl. C09K 5/04; F25B 30/02

(52) U.S. Cl. CPC C09K 5/045; F25B 30/02; C09K 2205/122; C09K 2205/126; C09K 2205/22

(57) ABSTRACT

A heat transfer composition and a heat pump are provided. The heat transfer composition may comprise a mixed refrigerant including, based on the total weight of the mixed refrigerant, 7 to 13 wt % of a flammable refrigerant, 18 to 48 wt % of 1,1-difluoroethane (R-152a), 8 to 67 wt % of trans-1,3,3,3-tetrafluoropropene (R-1234ze(E)), and 38 wt % or less of a non-flammable refrigerant, wherein the mixed refrigerant may have a boiling point at 1 atm of −33 degrees C or lower, and a latent heat at −30 degrees C of 217 KJ/kg or more. The heat pump may include the above-described heat transfer composition.

### CROSS-REFERENCE TO RELATED APPLICATIONS

This application claims priority to and the benefit of Korean Patent Application Nos. 10-2025-0064127, filed on May 16, 2025, and 10-2026-0007381, filed on Jan. 14, 2026, filed with Ministry of Intellectual Property (MOIP), and all the benefits accruing therefrom under 35 U.S.C. § 119. The entire contents of the foregoing applications are incorporated herein by reference.

### BACKGROUND

### 1. Field

The disclosure of the present application relates to a heat transfer composition and a heat pump including the same.

### 2. Description of the Related Art

A heating, ventilation and air conditioning (HVAC) system is configured to control the temperature, humidity, air composition, and airflow of an indoor environment to maintain a comfortable state. Such systems may include cooling, heating, and ventilation functions. Such HVAC systems are applicable to various spaces including buildings, factories, residential facilities, vehicles, and aircraft.

A refrigerant may be used as a heat transfer medium for cooling, heating, and the like, and may be used together with a refrigeration oil and additives. For example, a fluorinated hydrocarbon compound may be used as a refrigerant.

For example, a heat pump may be applied to the HVAC system. The heat pump operates using a refrigerant circulation process including evaporation, compression, condensation, and expansion, thereby absorbing heat from a low-temperature external environment, and transferring the heat to a high-temperature indoor environment, or conversely, discharging heat from the indoor environment to the outside.

### SUMMARY

An object of the present disclosure is to provide a heat transfer composition that has improved heating and cooling performance, energy efficiency, and environmental friendliness.

Another object of the present disclosure is to provide a heat pump that has improved heating and cooling performance, energy efficiency, and environmental friendliness.

A heat transfer composition according to embodiments of the present disclosure may comprise a mixed refrigerant including, based on the total weight of the mixed refrigerant, 7% by weight to 13% by weight of a flammable refrigerant other than 1,1-difluoroethane (R-152a) and trans-1,3,3,3-tetrafluoropropene (R-1234ze(E)), 18% by weight to 48% by weight of 1,1-difluoroethane (R-152a), 8% by weight to 67% by weight of trans-1,3,3,3-tetrafluoropropene (R-1234ze(E)), and 38% by weight or less of a non-flammable refrigerant, wherein the mixed refrigerant may have a boiling point at 1 atm of −33 °C or lower, and a latent heat at −30 °C of 217 KJ/kg or more.

In an embodiment, the heat transfer composition may have a heat rejection per unit volume of greater than 837 KJ/m³ in a heating cycle operated under conditions of a condenser temperature of 65 °C, an evaporator temperature of −30 °C, a superheat of 10 °C, and a subcooling of 5 °C.

In an embodiment, the mixed refrigerant may have a temperature glide of less than 9 °C at a pressure of 1.5 bar.

In an embodiment, the mixed refrigerant does not include 2,3,3,3-tetrafluoropropene (R-1234yf).

In an embodiment, the heat transfer composition may satisfy Equation 1 below:

0.85 (less than or equal to)(W3+W4)/(W1+W2) [Equation 1]
in Equation 1, W1 represents a content of the flammable refrigerant, W2 represents a content of 1,1-difluoroethane (R-152a), W3 represents a content of the non-flammable refrigerant, and W4 represents a content of trans-1,3,3,3-tetrafluoropropene (R-1234ze(E)), and each content is expressed in a weight percent (wt %) relative to the total weight of the mixed refrigerant.

In an embodiment, the heat transfer composition may satisfy Equation 1-1 below:

1.7(less than or equal to)(W3+W4)/(W1+W2)(less than or equal to)3.9 [Equation 1-1]
in Equation 1-1, W1 represents the content of the flammable refrigerant other than 1,1-difluoroethane (R-152a) and trans-1,3,3,3-tetrafluoropropene (R-1234ze(E)), W2 represents the content of 1,1-difluoroethane (R-152a), W3 represents the content of the non-flammable refrigerant, and W4 represents the content of trans-1,3,3,3-tetrafluoropropene (R-1234ze(E)), and each content is expressed in a weight percent (wt %) relative to the total weight of the mixed refrigerant.

In an embodiment, the temperature glide of the mixed refrigerant at a pressure of 1.5 bar may be 6.0 °C to 8.9 °C.

In an embodiment, the heat transfer composition may satisfy Equation 2 below:

(W2+W4)/W1<7.6 [Equation 2]
in Equation 2, W1 represents a content of the flammable refrigerant other than 1,1-difluoroethane (R-152a) and trans-1,3,3,3-tetrafluoropropene (R-1234ze(E)), W2 represents a content of 1,1-difluoroethane (R-152a), and W4 represents a content of trans-1,3,3,3-tetrafluoropropene (R-1234ze(E)), and each content is expressed in a weight percent (wt %) relative to the total weight of the mixed refrigerant.

In an embodiment, the boiling point of the mixed refrigerant at 1 atm may be −34 °C or lower.

In an embodiment, the heat transfer composition may satisfy Equation 2-1 below:

5 (less than or equal to)(W2+W4)/W1<7.6 [Equation 2-1]
in Equation 2-1, W1 represents the content of the flammable refrigerant other than 1,1-difluoroethane (R-152a) and trans-1,3,3,3-tetrafluoropropene (R-1234ze(E)), W2 represents the content of 1,1-difluoroethane (R-152a), and W4 represents the content of trans-1,3,3,3-tetrafluoropropene (R-1234ze(E)), and each content is expressed in a weight percent (wt %) relative to the total weight of the mixed refrigerant.

In an embodiment, the latent heat of the mixed refrigerant at −30 °C may be 220 KJ/kg to 250 KJ/kg.

In an embodiment, a total content of 1,1-difluoroethane (R-152a) and trans-1,3,3,3-tetrafluoropropene (R-1234ze(E)) may be 55% by weight to 90% by weight, based on the total weight of the mixed refrigerant.

In an embodiment, a total content of the non-flammable refrigerant and trans-1,3,3,3-tetrafluoropropene (R-1234ze(E)) may be 60% by weight to 75% by weight, based on the total weight of the mixed refrigerant.

In an embodiment, the heat transfer composition may include the flammable refrigerant in an amount of 8% by weight to 12% by weight, based on the total weight of the mixed refrigerant.

In an embodiment, the heat transfer composition may include 1,1-difluoroethane (R-152a) in an amount of 20% by weight to 23% by weight, based on the total weight of the mixed refrigerant.

In an embodiment, the heat transfer composition may include trans-1,3,3,3-tetrafluoropropene (R-1234ze(E)) in an amount of 49% by weight to 53% by weight, based on the total weight of the mixed refrigerant.

In an embodiment, the heat transfer composition may include the non-flammable refrigerant in an amount of 16% by weight to 19% by weight, based on the total weight of the mixed refrigerant.

In an embodiment, the heat transfer composition may further include at least one of a base oil and an additive.

A heat pump according to embodiments of the present disclosure may include the above-described heat transfer composition.

In an embodiment, the heat pump may include a compressor; an outdoor heat exchanger; an indoor heat exchanger; an expansion valve; and the above-described heat transfer composition, wherein the heat pump is configured to operate in a heating mode in which the outdoor heat exchanger functions as an evaporator and the indoor heat exchanger functions as a condenser, and in a cooling mode in which the outdoor heat exchanger functions as a condenser and the indoor heat exchanger functions as an evaporator.

In an embodiment, the heat pump may have a coefficient of performance (COP) of 2.0 or greater in a heating mode operated under conditions of an ambient temperature of −20 °C, a condenser temperature of 65 °C, an evaporator temperature of −30 °C, a superheat of 10 °C, and a subcooling of 5 °C.

In an embodiment, the heat transfer composition may have a volumetric heating capacity of 860 KJ/m³ to 940 KJ/m³ in a heating cycle operated under conditions of a condenser temperature of 65 °C, an evaporator temperature of −30 °C, a superheat of 10 °C, and a subcooling of 5 °C.

In an embodiment, the mixed refrigerant may have a global warming potential (GWP) of 110 or less, based on a 100-year time horizon. In some embodiments, the ratio (R) of the total number of F and I atoms to the total number of F, I, and H atoms included in the mixed refrigerant is 0.46 to 0.58, wherein R=(F+I)/(F+I+H).

A method for cooling a space using the heat pump according to the present disclosure may comprise: compressing the heat transfer composition through a compressor; releasing heat in an outdoor heat exchanger functioning as a condenser; expanding the heat transfer composition through an expansion valve; and absorbing heat through an indoor heat exchanger functioning as an evaporator.

A method for heating a space using the heat pump according to the present disclosure may comprise: compressing the heat transfer composition through a compressor; releasing heat in an indoor heat exchanger functioning as a condenser; expanding the heat transfer composition through an expansion valve; and absorbing heat from an outdoor heat exchanger functioning as an evaporator.

In an embodiment, the method for heating a space using the heat pump may comprise: compressing, in a compressor, a heat transfer composition to a high-temperature and high-pressure gaseous state; releasing heat from the compressed heat transfer composition in an indoor heat exchanger functioning as a condenser to heat the space, thereby condensing the heat transfer composition; expanding the condensed heat transfer composition through an expansion valve; and absorbing heat from outdoor air in an outdoor heat exchanger functioning as an evaporator, wherein the heat transfer composition comprises a mixed refrigerant, and the mixed refrigerant comprises, based on the total weight of the mixed refrigerant, 7 wt % to 13 wt % of a flammable refrigerant, 18 wt % to 48 wt % of 1,1-difluoroethane (R-152a), 8 wt % to 67 wt % of trans-1,3,3,3-tetrafluoropropene (R-1234ze(E)), and 38 wt % or less of a non-flammable refrigerant, and wherein the mixed refrigerant has a boiling point at 1 atm of −33 °C or lower and a latent heat at −30 °C of 217 KJ/kg or more.

In an embodiment, the above method for cooling a space and the above method for heating a space may be performed by switching between a cooling mode and a heating mode in a single heat pump or heat pump system to perform a heat exchange cycle of the heat transfer composition. Optionally, a valve configured to selectively switch a flow path of the heat transfer composition and to control a flow direction of the heat transfer composition when switching between the cooling mode and the heating mode may be used, and an accumulator configured to temporarily store the heat transfer composition or to perform gas-liquid separation and to stabilize a state of the heat transfer composition flowing into the compressor may be further used.

In an embodiment, the heat transfer composition may improve energy efficiency of the heat pump by transferring heat without a reduction in circulation efficiency of the heat transfer composition and without an excessive reduction in evaporation pressure.

The heat transfer composition according to embodiments of the present disclosure may exhibit improved heating and cooling performance, energy efficiency, and environmental friendliness.

The heat pump according to embodiments of the present disclosure may exhibit improved heating and cooling performance, energy efficiency, and environmental friendliness.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a schematic view illustrating the flow of a refrigerant for heat exchange in a cooling mode of a heat exchanger within a heat pump-type circulation system according to an embodiment; and

FIG. 2 is a schematic view illustrating the flow of a refrigerant for heat exchange in a heating mode of a heat exchanger within a heat pump-type circulation system according to an embodiment.

### DETAILED DESCRIPTION

Hereinafter, exemplary embodiments of the present disclosure will be described in detail with reference to the drawings so that persons of ordinary knowledge in the technical field to which the present invention pertains may easily implement the present invention. Described herein below are heat transfer compositions comprising a mixed refrigerant designed to achieve a combination of thermodynamic, environmental, and safety properties that the specification presents as collectively unattainable by existing refrigerants. For example, in certain embodiments, the compositions balance desired properties across competing properties to achieve low-temperature heating performance (e.g., at ambient temperatures as low as −20 °C), high latent heat (improves the heat transfer efficiency of the system), high volumetric heating capacity (e.g., can deliver more heating capacity with a smaller compressor displacement), low global warming (GWP) potential, controlled temperature glide, safety (e.g., lower toxicity), and/or high energy efficiency.

### <Heat Transfer Composition>

A heat transfer composition according to embodiments of the present disclosure comprises a mixed refrigerant including, based on the total weight of the mixed refrigerant, 7% by weight (“wt %”) to 13 wt % of a flammable refrigerant, 18 wt % to 48 wt % of 1,1-difluoroethane (R-152a), 8 wt % to 67 wt % of trans-1,3,3,3-tetrafluoropropene (R-1234ze(E)), and 38 wt % or less of a non-flammable refrigerant, wherein the mixed refrigerant may have a boiling point at 1 atm of −33 °C or lower, and a latent heat at −30 °C of 217 KJ/kg or more.

In the present disclosure, the mixed refrigerant may be a mixture that includes the flammable refrigerant (exempting R-152a and R-1234ze(E) from consideration of the amount of the flammable refrigerant), the non-flammable refrigerant, 1,1-difluoroethane (R-152a), and trans-1,3,3,3-tetrafluoropropene (R-1234ze(E)). For example, the mixed refrigerant may refer to the entirety of a mixture that includes the flammable refrigerant, the non-flammable refrigerant, 1,1-difluoroethane (R-152a), and trans-1,3,3,3-tetrafluoropropene (R-1234ze(E)).

The mixed refrigerant may refer to a total of refrigerant components, optionally excluding other components such as refrigeration oil and additives.

Unless otherwise specified, the boiling point, latent heat, temperature glide, and global warming potential (GWP) described in this specification and claims may be measured or calculated based on the mixed refrigerant.

The flammable refrigerant (not considering R-152a and R-1234ze(E) for the purpose of the accounting for compositional contents in the present disclosure) may refer to a refrigerant that exhibits flame propagation from an ignition source under standard atmospheric pressure and room temperature conditions. The flammable refrigerant may refer to a refrigerant having a burning velocity exceeding 0 cm/s or having a lower flammability limit (LFL) when evaluated for flammability classification according to ISO 817 or ASHRAE Standard 34. For example, the flammable refrigerant may include a refrigerant classified as an A2L class (lower flammability flammable refrigerant), an A2 class (flammable), or an A3 class (highly flammable) under these standards.

The flammable refrigerant other than R-152a and R-1234ze(E) may include at least one selected from the group consisting of, for example, difluoromethane (R-32), 1,1,1-trifluoroethane (R-143a), fluoroethane (R-161), fluoromethane (R-41), 2,3,3,3-tetrafluoropropene (R-1234yf), 1,1-difluoroethylene (R-1132a), n-butane (R-600), isobutane (R-600a), trans-1,2-difluoroethylene (R-1132 (E)), propylene (R-1270), propane (R-290), and mixtures thereof.

The non-flammable refrigerant may refer to a refrigerant that does not exhibit flame propagation from an ignition source under standard atmospheric pressure and room temperature conditions. For example, the non-flammable refrigerant may refer to a refrigerant in which flame propagation is not observed and therefore cannot be measured, or in which the burning velocity is regarded as 0 cm/s, when evaluated for flammability classification according to ISO 817 or ASHRAE Standard 34. The non-flammable refrigerant may include, for example, a refrigerant classified as an A1 class (non-flammable).

The non-flammable refrigerants may include at least one selected from the group consisting of, for example, trifluoroiodomethane (R-1311), perfluoro (2-methyl-3-pentanone) (FK-May 1, 2012), 2-chloro-1,1,1,2-tetrafluoroethane (R-124), pentafluoroethane (R-125), 1,1,1,2,3,3,3-heptafluoropropane (R-227ea), trifluoromethane (R-23), 1,1,1,3,3,3-hexafluoropropane (R-236fa), 1,1,1,2-tetrafluoroethane (R-134a), trans-1-chloro-3,3,3-trifluoropropene (R-1233zd (E)), (Z)-1-chloro-2,3,3,3-tetrafluoropropene (R-1224 yd (Z)), trans-1,1,1,4,4,4-hexafluoro-2-butene (R-1336mzz(E)), cis-1,1,1,4,4,4-hexafluoro-2-butene (R-1336mzz(Z)), and mixtures thereof.

A person having ordinary skill in the art may use REFPROP (Version 10.0) to calculate the boiling point, latent heat, and other thermodynamic properties for any particular combination of components within the ranges specified herein and may thereby confirm whether a given combination satisfies the property limitations of the present disclosure.

In an embodiment, the mixed refrigerant may not include a non-flammable refrigerant. That is, the non-flammable refrigerant content may be 0% by weight. As shown in Examples 35 through 37, a mixed refrigerant consisting of a flammable refrigerant, 1,1-difluoroethane (R-152a), and trans-1,3,3,3-tetrafluoropropene (R-1234ze(E)), without any non-flammable refrigerant, may still satisfy the boiling point and latent heat limitations described herein. However, the absence of a non-flammable refrigerant may result in a higher GWP (as shown in Example 35, which exhibited a GWP of 111), a higher temperature glide, or a lower heat rejection per unit volume compared to embodiments that include a non-flammable refrigerant such as trifluoroiodomethane (R-13I1).

Accordingly, embodiments including a nonflammable refrigerant are generally preferred when both low GWP and high heating performance are desired.

According to the heat transfer composition, both cooling performance and heating performance may be improved, enabling stable thermal management regardless of the season. In addition, because there is no need to install an additional heating device even in winter, the energy efficiency of the entire system may be improved. The heat transfer composition may absorb or release more heat on a per-unit-mass basis, thereby reducing the energy consumption of the entire system.

The boiling point of the mixed refrigerant may be calculated, for example, using REFPROP (Version 10.0), a thermodynamic analysis program provided by the National Institute of Standards and Technology (NIST) of the United States. For example, the boiling point of the mixed refrigerant may be defined as a bubble-point temperature calculated under a pressure condition of 1 atm (101.325 kPa).

The latent heat of the mixed refrigerant may be calculated, for example, using REFPROP (Version 10.0) provided by the National Institute of Standards and Technology (NIST), based on saturated conditions at −30 °C. For example, the latent heat may be defined as a difference between the enthalpy of a saturated vapor state and the enthalpy of a saturated liquid state at −30 °C.

In an embodiment, the heat transfer composition may have a heat rejection per unit volume of greater than 837 KJ/m³ in a heating cycle operated under conditions of a condenser temperature of 65 °C, an evaporator temperature of −30 °C, a superheat of 10 °C, and a subcooling of 5 °C.

In the present disclosure, the heat rejection per unit volume of the heat transfer composition may refer to a value obtained by multiplying an amount of heat released from a condenser in a heating cycle operated under the above-described conditions by the volumetric efficiency of a compressor and the density of the mixed refrigerant at an inlet of the compressor. The heat rejection per unit volume is a heating performance indicator converted on the basis of the compressor suction volume, and may be used as an indicator for comparing and evaluating the heating performance among different heat transfer compositions.

In an embodiment, the heat transfer composition does not include 2,3,3,3-tetrafluoropropene (R-1234yf). 2,3,3,3-tetrafluoropropene tends to be more reactive toward non-flammable refrigerants, such as trifluoroiodomethane (R-13I1). Accordingly, when the heat transfer composition includes 2,3,3,3-tetrafluoropropene and is operated within a heating system for an extended period of time, chemical changes or deposits may occur in the heat exchanger, leading to a reduction in heat exchange performance and a gradual degradation of heating performance.

For example, the heat transfer composition may exhibit an increase in heat rejection per unit volume of about 110% or more compared to a composition that includes 2,3,3,3-tetrafluoropropene (R-1234yf). In this case, the amount of heat that can be transferred per unit time may increase, thereby reducing a circulation amount of the heat transfer composition required to achieve the same heating performance. Accordingly, the system load and energy consumption, for example, of a heat pump, may be reduced.

For example, the heat transfer composition may exhibit an increase in the latent heat of the mixed refrigerant at −30 °C of about 120% or more compared to a composition that includes 2,3,3,3-tetrafluoropropene (R-1234yf). In this case, heat exchange during the evaporation and condensation of the mixed refrigerant may proceed more gradually, thereby improving the operational stability and controllability of the entire system.

In an embodiment, the heat transfer composition may satisfy Equation 1 below.

0.85≤(W3+W4)/(W1+W2) [Equation 1]

In Equation 1, W1 represents a content of the flammable refrigerant other than R-152a and R-1234ze(E), W2 represents a content of 1,1-difluoroethane (R-152a), W3 represents a content of the non-flammable refrigerant, and W4 represents a content of trans-1,3,3,3-tetrafluoropropene (R-1234ze(E)), and each content is expressed in a weight percent (wt %) relative to the total weight of the mixed refrigerant. Accordingly, the heating performance of the heat transfer composition at low temperatures may be further improved.

In an embodiment, the heat transfer composition may satisfy Equation 1-1 below:

1.7≤(W3+W4)/(W1+W2)≤3.9 [Equation 1-1]

In Equation 1-1, W1 to W4 refer to the definitions described above.

Since the respective contents of the flammable refrigerant (counting the flammable refrigerant content exempting the content of R-152a and R-1234ze(E)), 1,1-difluoroethane (R-152a), and trans-1,3,3,3-tetrafluoropropene (R-1234ze(E)) satisfy the relationship defined by Equation 1-1, the boiling point of the mixed refrigerant at 1 atm may be further lowered, thereby improving heat absorption efficiency under conditions of low ambient temperatures in winter. In addition, by further increasing the heat rejection per unit volume and the latent heat at low temperatures, heat exchange efficiency may be improved without a reduction in heating output.

Equation 1-1 defines a more preferred composition ratio range within the range defined by Equation 1, which may further improve the low-temperature heating performance of the heat transfer composition, increase the heat rejection per unit volume, and improve low-temperature latent heat, thereby contributing to stable evaporation operation under low-temperature environments, as well as improved heat exchange efficiency and system controllability. In addition, within the composition ratio range represented by Equation 1-1, the proportion of relatively highly flammable components may be controlled, thereby maintaining a balanced contribution of non-flammable or low-flammability components, thereby suppressing or reducing the overall flammability of the composition.

In an embodiment, the mixed refrigerant may have a temperature glide of 6.0 °C to 9.0 °C at a pressure of 1.5 bar, for example, 6.5 °C to 8.7 °C, or 7.0 °C to 8.5 °C. Accordingly, the evaporation and condensation processes of the mixed refrigerant may proceed in a stable manner, thereby improving the efficiency of the heat exchanger and reducing the energy consumption of the entire system.

If the temperature glide of the mixed refrigerant is excessively low or excessively high, heat exchange efficiency may be adversely affected. For example, if the temperature glide is too low, the evaporation (or condensation) temperature change of the mixed refrigerant may be limited, thereby preventing sufficient temperature profile matching with a heat source (or heat sink) and resulting in suboptimal heat exchange. Conversely, if the temperature glide is excessively high, structural modifications, such as increasing the heat exchanger length, may be required, which may cause a decrease in the performance of an air-source-based heat pump system under low ambient temperature conditions.

In the present disclosure, temperature glide may refer to the difference between the dew point temperature and the bubble point temperature of a mixed refrigerant measured under the same constant-pressure conditions and thermodynamic equilibrium conditions. For example, the temperature glide may be defined as the difference between the dew point temperature and the bubble point temperature, calculated using REFPROP (Version 10.0) provided by the National Institute of Standards and Technology (NIST) under constant-pressure conditions of 1.5 bar.

In an embodiment, the heat transfer composition may have a heat rejection per unit volume of 839 KJ/m³ to 960 KJ/m³, 850 KJ/m³ to 960 KJ/m³, 850 KJ/m³ to 950 KJ/m³, 850 KJ/m³ to 945 KJ/m³, or 860 KJ/m³ to 940 KJ/m³.

In an embodiment, the heat transfer composition may have a global warming potential (GWP) of 110 or less, or 100 or less. Accordingly, compliance with environmental regulations may be more readily achieved, and negative impacts on the environment may be reduced.

In an embodiment, the mixed refrigerant may have a latent heat at −30 °C of 210 KJ/kg to 250 KJ/kg, 215 KJ/kg to 245 KJ/kg, 217 KJ/kg to 245 KJ/kg, 220 KJ/kg to 245 KJ/kg, or 220 KJ/kg to 240 KJ/kg.

In an embodiment, the heat transfer composition may satisfy Equation 2:

(W2+W4)/W1<7.6 [Equation 2]

In Equation 2, W1 represents the content of the flammable refrigerant other than R-152a and R-1234ze(E), W2 represents the content of 1,1-difluoroethane (R-152a), and W4 represents the content of trans-1,3,3,3-tetrafluoropropene (R-1234ze(E)). Each content is expressed in a weight percent (wt %.) relative to the total weight of the mixed refrigerant.

Accordingly, the condensation pressure and evaporation pressure of the mixed refrigerant may be more stably maintained.

In an embodiment, the boiling point of the mixed refrigerant at 1 atm may be −33 °C or lower, −33.5 °C or lower, or −34 °C or lower, or may be within a range of −38 °C to −34 °C, −37 °C to −34 °C, or −36.5 °C to −34 °C.

In an embodiment, the heat transfer composition may satisfy Equation 2-1 below:

5≤(W2+W4)/W1<7.6 [Equation 2-1]

In Equation 2-1, W1, W2, and W4 refer to the definitions described above.

In an embodiment, the latent heat of the mixed refrigerant at −30 °C may be 220 KJ/kg to 250 KJ/kg.

The heat transfer composition may stably transfer heat without a reduction in the circulation efficiency of the mixed refrigerant and without an excessive reduction in the evaporation pressure, even in low-temperature environments such as winter. Accordingly, sufficient heating performance may be achieved even under low ambient temperature conditions without the need for a separate auxiliary heater, thereby improving the energy efficiency of the heat pump system.

In an embodiment, a total content of 1,1-difluoroethane (R-152a) and trans-1,3,3,3-tetrafluoropropene (R-1234ze(E)) may be 55 wt % to 90 wt %, based on the total weight of the mixed refrigerant. Accordingly, the heat transfer composition may maintain high heat transfer performance while improving environmental friendliness.

In an embodiment, a total content of the non-flammable refrigerant and trans-1,3,3,3-tetrafluoropropene (R-1234ze(E)) may be 60 wt % to 75 wt %, based on the total weight of the mixed refrigerant. Accordingly, the heat transfer composition may have a low GWP while maintaining high heat transfer performance.

In an embodiment, the heat transfer composition may include the flammable refrigerant other than R-152a and R-1234ze(E) in an amount of 8 wt % to 12 wt %, based on the total weight of the mixed refrigerant. Accordingly, the heat transfer composition may exhibit further improved heat transfer performance.

In an embodiment, the heat transfer composition may include 1,1-difluoroethane (R-152a) in an amount of 20 wt % to 48 wt %, based on the total weight of the mixed refrigerant.

In an embodiment, the heat transfer composition may include 1,1-difluoroethane (R-152a) in an amount of 20 wt % to 23 wt %, based on the total weight of the mixed refrigerant. Accordingly, the heat transfer composition may have a lower global warming potential (GWP) and improved stability due to controlled flammability.

In an embodiment, the heat transfer composition may include trans-1,3,3,3-tetrafluoropropene (R-1234ze(E)) in an amount of 49 wt % to 53 wt %, based on the total weight of the mixed refrigerant. Accordingly, the heat transfer composition may exhibit further improved heating performance under low-temperature conditions and improved environmental friendliness. In an embodiment, the heat transfer composition may include the non-flammable refrigerant in an amount of 16 wt % to 19 wt %, based on the total weight of the mixed refrigerant. Accordingly, efficiency in the heat exchange process may be improved.

Without wishing to be bound by theory, the content of each component in the mixed refrigerant may be specified within the ranges described herein because compositions falling outside these ranges may exhibit deteriorated performance in one or more critical properties.

The flammable refrigerant content may be about 7% by weight to about 13% by weight, based on the total weight of the mixed refrigerant, because below about 7% by weight, the boiling point at 1 atm may rise above about −33 °C and the heat rejection per unit volume may fall below 837 KJ/m³ due to reduced vapor density at the compressor inlet (see Comparative Examples 2 and 5), whereas above about 13% by weight, the GWP may increase to an unacceptable level and the temperature glide at 1.5 bar may exceed 9 °C, adversely affecting heat exchanger efficiency (see Comparative Examples 1 and 3).

The content of 1,1-difluoroethane (R-152a) may be about 18% by weight to about 48% by weight because below about 18% by weight, the latent heat at −30 °C may fall below 217 KJ/kg and the composition may fail to satisfy Equation 1-1 (see Comparative Examples 4 and 5), whereas above about 48% by weight, the boiling point may rise above −33 °C and the ratio (W2+W4)/W1 may significantly exceed 7.6, thereby destabilizing the condensation and evaporation pressures (see Comparative Example 2).

The content of trans-1,3,3,3-tetrafluoropropene (R-1234ze(E)) may be about 8% by weight to about 67% by weight because, although R-1234ze(E) has a very low GWP (GWP=7) and helps maintain a favorable safety classification, above about 67% by weight the boiling point may rise above −33 °C and the heat rejection per unit volume may be significantly reduced (see Comparative Example 5), whereas below about 8% by weight the GWP may increase and the ATEL may fall below 10,000 ppm, resulting in a high-toxicity classification (see Comparative Example 4).

The content of the non-flammable refrigerant (e.g., trifluoroiodomethane (R-13I1)) may be about 38% by weight or less because above that level the latent heat may drop significantly below 217 KJ/kg and the ATEL may fall below 10,000 ppm (see Comparative Example 4), although the non-flammable refrigerant may be 0% by weight as illustrated by Examples 35 through 37.

In an embodiment, a ratio (R) of the total number of F and I atoms to the total number of F, I and H atoms included in the heat transfer composition may be 0.46 to 0.58, or 0.54 to 0.58. The ratio (R) may be calculated according to Equation R=(F+I)/(F+I+H). The R value used herein may be calculated based on the molecular formulas of halogenated hydrocarbon compounds included in the heat transfer composition, by summing the numbers of atoms of fluorine (F), iodine (I) and/or hydrogen (H) contained in the molecules. For example, the number of fluorine atoms, F, may be equal to the total number of fluorine atoms contained in all halogenated hydrocarbon compounds included in the heat transfer composition, the number of iodine atoms, I, may be equal to the total number of iodine atoms, and the number of hydrogen atoms, H, may be equal to the total number of hydrogen atoms.

If the R value is too low, flammability may increase, thereby increasing the risk of explosion. In addition, the boiling point may increase, thereby reducing low-temperature heating performance. Conversely, if the R value is too high, chemical stability may be reduced, and compliance with the acute toxicity exposure limit (ATEL) regulations may not be achieved.

The acute toxicity exposure limit (ATEL) refers to the concentration of a mixed refrigerant that is considered non-hazardous to humans when inhaled for a short period of time (typically within 1 hour), and is expressed in units of ppm. The ATEL may be calculated based on inhalation toxicity data for each component, such as lethal concentration (LC₅₀, inhalation), and by applying an appropriate safety factor according to ASHRAE Standard 34. As a non-limiting example, acute toxicity classification as a safety class may be conducted according to ISO 817 and ASHRAE Standard 34, “Designation and Safety Classification of Refrigerants.” For example, the toxicity class may be determined based on the lowest value among the lethal concentration (LC₅₀), cardiac sensitization value, and anesthesia value for each component. The overall acute toxicity exposure limit (ATEL) of the mixed refrigerant in the heat transfer composition may be calculated according to a weighted harmonic mean method based on the mole fraction of each component. If the calculated overall ATEL value is 10,000 ppm or more, it may be classified as a low-toxicity class, and if it is less than 10,000 ppm, it may be classified as a high-toxicity class.

In an embodiment, the heat transfer composition may optionally further include at least one of CFH3, CHF3, C3F8, C2HF5, CH3CF3, and CHF2C1.

In an embodiment, the mixed refrigerant may consist of a flammable refrigerant other than R-152a and R-1234ze(E), 1,1-difluoroethane (R-152a), trans-1,3,3,3-tetrafluoropropene (R-1234ze(E)), and a non-flammable refrigerant.

Accordingly, the boiling point of the mixed refrigerant may be controlled to −33 °C or lower, −33.5 °C or lower, or −34 °C or lower, −38 °C to −34 °C, −37 °C to −34 °C, or −36.5 °C to −34 °C (thereby achieving a relatively lower level), and the heat rejection per unit volume of the heat transfer composition may be controlled to 839 KJ/m³ to 960 KJ/m³, 850 KJ/m³ to 960 KJ/m³, 850 KJ/m³ to 950 KJ/m³, 850 KJ/m³ to 945 KJ/m³, or 860 KJ/m³ to 940 KJ/m³ (thereby achieving a relatively higher level), thereby further improving both the cooling performance and the heating performance of the composition.

In an embodiment, the mixed refrigerant may include difluoromethane (R-32), 1,1-difluoroethane (R-152a), trans-1,3,3,3-tetrafluoropropene (R-1234ze(E)), and trifluoroiodomethane (R-13I1).

In an embodiment, the heat transfer composition may consist of the mixed refrigerant, and in this case, the heat transfer composition may be referred to as the mixed refrigerant.

In an embodiment, the heat transfer composition may further include at least one of a base oil and an additive.

In an embodiment, a weight ratio of the mixed refrigerant to the base oil may be 1:9 to 9:1

In an embodiment, the heat transfer composition may include the additive in an amount of 0.01 wt % to 5 wt %, based on the total weight of the heat transfer composition.

In an embodiment, the base oil may include at least one selected from the group consisting of, for example, polyol ester, polyalphaolefin, polyalkylene glycol, diester, polycarbonate, alkylbenzene, polyvinyl ether, polyether, perfluoropolyether, mineral oil, and phosphate ester.

In an embodiment, the additive may include at least one of an antioxidant, a corrosion inhibitor, an acid scavenger, an extreme pressure additive, an antiwear agent, and a stabilizer to improve the stability, wear resistance, and heat resistance of the refrigeration oil.

In an embodiment, the antioxidant may include at least one of a phenol-based antioxidant, an amine-based antioxidant, a phosphorus-based antioxidant, and a sulfur-based antioxidant.

The antioxidant may include, for example, a phenol-based antioxidant such as 2,6-di-tert-butylphenol, and 2,6-di-tert-butyl-4-methylphenol (BHT); an amine-based antioxidant such as phenylamine, diphenylamine, and naphthylamine; a phosphorus-based antioxidant such as trialkyl phosphites, trialkyl phosphates, and trialkyl phosphines; and a sulfur-based antioxidant such as pentaerythrityl tetrakis (3-laurylthiopropionate), dilauryl thiodipropionate, distearyl thiodipropionate, and/or ditridecyl thiodipropionate and dimyristyl thiodipropionate.

In an embodiment, the corrosion inhibitor may include at least one of a thiazole compound, a triazole compound, and a thiadiazole compound.

In an embodiment, the acid scavenger may improve stability by capturing acidic impurities that may be included in the refrigeration oil or a refrigeration composition.

The acid scavenger may include, for example, a glycidyl ether compound, and may include, for example, triglycidyl ether, diglycidyl ether, glycidyl ether, lauryl glycidyl ether, and/or ethylhexyl glycidyl ether.

In an embodiment, the extreme pressure additive may reduce friction and wear by preventing direct metal-to-metal contact.

The extreme pressure additive may be an organosulfur compound extreme pressure additive, a phosphorothioate ester extreme pressure additive, an ester-type extreme pressure additive, an organochlorine extreme pressure additive, an organofluorine extreme pressure additive, an alcohol-type extreme pressure additive, or a metal compound extreme pressure additive. The organosulfur compound extreme pressure additive may be a monosulfide, a polysulfide, a sulfoxide, a sulfone, a thiosulfinate, a sulfurized oil, a thiocarbonate, a thiophene, a thiazole, or a methanesulfonate. The ester-type extreme pressure additive may be a long-chain fatty acid, a hydroxyaryl fatty acid, a polyol ester, or an acrylate. The organochlorine extreme pressure additive may be a chlorinated hydrocarbon or a chlorinated carboxylic acid derivative. The organofluorine extreme pressure additive may be a fluorinated aliphatic carboxylic acid, a fluoroethylene resin, a fluoroalkyl polysiloxane, or a fluorinated graphite. The metal compound extreme pressure additive may be a naphthenate (such as lead naphthenate), a fatty acid salt (such as a lead fatty acid salt), a thiophosphate (such as zinc dialkyldithiophosphate), a thiocarbamate, an organic molybdenum compound, an organic tin compound, or an organic germanium compound.

In an embodiment, the antiwear agent may include a phosphate antiwear agent. The phosphate antiwear agent may include, for example, at least one of a trialkyl phosphate and a triaryl phosphate, and may include, for example, tributyl phosphate, tripentyl phosphate, trihexyl phosphate, triphenyl phosphate, tris (methylphenyl) phosphate, and/or tricresyl phosphate.

The stabilizer may include at least one selected from the group consisting of, for example, paraffin, naphthene, aromatic hydrocarbon, benzene or naphthalene that is unsubstituted or substituted with a linear or branched alkyl group, polyvinylpyrrolidone, and dibenzyl toluene. The naphthalene substituted with an alkyl group may be referred to as an alkylated naphthalene and may include, for example, monoalkyl naphthalene, dialkyl naphthalene, trialkyl naphthalene, tetraalkyl naphthalene, or mixtures thereof.

In an embodiment, the heat transfer composition may be a mixed refrigerant composition.

The heat transfer composition may be applied to heat exchange devices such as household and/or industrial refrigerators, cold storage facilities, refrigeration units, household and/or commercial air conditioners, automotive air conditioning systems, vapor-compression heat pumps, data centers and/or server cooling systems, and the like, but is not limited thereto and may be used in a variety of heat transfer applications.

### <Heat Pump>

A heat pump according to an embodiment of the present disclosure includes the above-described heat transfer composition.

Accordingly, the heat pump may exhibit improved heat transfer characteristics and high-temperature stability. In particular, the heat pump may secure enhanced evaporation performance and heat transport capacity even in low-temperature environments, thereby stably maintaining heating performance even under low-temperature outdoor conditions such as winter.

Accordingly, standalone heating operation is possible without installing an additional auxiliary heating device, contributing to simplification of the system structure and improvement in energy efficiency.

The heat pump may include a compressor, a condenser, an expansion valve, and an evaporator, wherein the condenser and the evaporator may each function as a heat exchanger.

In the compressor, the mixed refrigerant may be compressed to a high-temperature and high-pressure gaseous state, and the mixed refrigerant may release heat in the condenser to be condensed into a liquid state. Thereafter, the mixed refrigerant may pass through the expansion valve, thereby expanding to a low-temperature and low-pressure state, and may absorb external heat in the evaporator to be vaporized into a gaseous state.

The condenser and the evaporator may function as heat exchangers that exchange heat via the mixed refrigerant, and the mixed refrigerant may repeatedly undergo processes of releasing or absorbing heat while circulating within the heat pump.

The heat pump may perform cooling or heating functions depending on its operating mode. In a cooling mode, the heat pump may release indoor heat to the outdoors, and in a heating mode, the heat pump may transfer outdoor heat to the indoors.

In some embodiments, a coefficient of performance (COP) of the heat pump may be 1 to 10. Here, the coefficient of performance (COP) refers to a ratio of effective heat obtained to energy input during operation of the heat pump. Accordingly, a high-efficiency heat pump having a COP of 1 to 10 may be provided by using the above-described mixed refrigerant.

The heat pump may be applied to various fields, including residential, commercial, and industrial applications, and may operate efficiently over a wide operating temperature range from −20 °C to 50 °C.

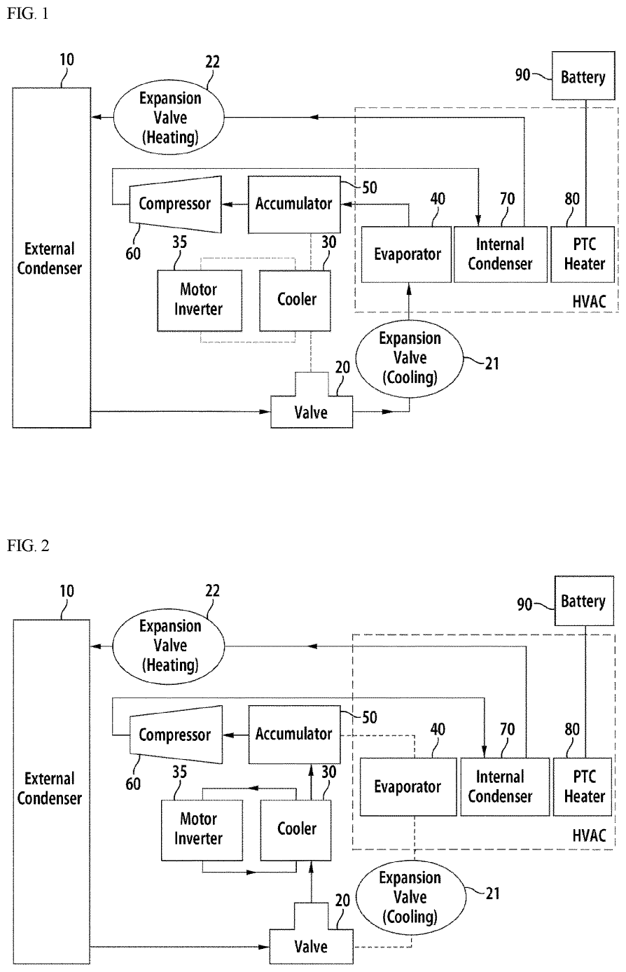

FIGS. 1 and 2 are schematic views illustrating the flow of the mixed refrigerant for heat exchange in a cooling mode or a heating mode of a heat exchanger within a heat pump according to an embodiment.

In FIGS. 1 and 2, the directions of the arrows indicate the flow path of the mixed refrigerant. Hereinafter, the mixed refrigerant may be referred to as “the refrigerant” for convenience. The flow of the refrigerant, as used herein, may be understood to include a flow of a refrigerant composition or a flow of a heat transfer composition including a refrigeration oil and a refrigerant.

Referring to FIG. 1, in a cooling mode, a refrigerant may be compressed by a compressor 60, may bypass an internal condenser 70 functioning as an indoor heat exchanger and an expansion valve (heating) 22, may release heat in an external condenser 10 functioning as an outdoor heat exchanger, may then expand while passing through an expansion valve (cooling) 21, and may subsequently absorb heat again through an evaporator 40.

For example, in the cooling mode, the refrigerant gas may be compressed by the compressor 60, thereby increasing its pressure and temperature. Accordingly, the refrigerant may be prepared to release heat when moving to the external condenser. When the system is in the cooling mode, the refrigerant may bypass the internal condenser 70 and the expansion valve (heating) 22 and may flow into the external condenser, where it may release heat to outdoor air and be condensed into a liquid. Thereafter, the liquid refrigerant may expand while passing through the expansion valve (cooling) 21, thereby decreasing its pressure and temperature. The low-temperature and low-pressure refrigerant may then flow into the evaporator 40, absorb heat from indoor air, and evaporate back into a gas, thereby completing the cycle.

Referring to FIG. 2, in a heating mode, the refrigerant may be compressed by the compressor 60, may release heat in an internal condenser 70 functioning as an indoor heat exchanger, may expand through an expansion valve (heating) 22, may absorb heat from an external condenser 10 functioning as an evaporator in the heating mode, and may further absorb heat through a cooler 30.

For example, in the heating mode, the refrigerant may first be compressed by the compressor 60, thereby increasing its pressure and temperature, and thus enabling effective heat release. The compressed refrigerant may then flow into the internal condenser 70, where the high-temperature refrigerant transfers energy to a space to be heated, thereby heating the space, and may be condensed into a liquid in this process. Thereafter, the refrigerant may pass through the expansion valve (heating) 22, thereby decreasing its pressure and temperature. The refrigerant may then flow into the external condenser 10, which functions as an evaporator in the heating mode, and may absorb heat from outdoor air even under low-temperature conditions. Subsequently, the refrigerant may pass through the cooler 30, absorb additional heat, and return to the compressor 60. The cooler may provide an additional heat absorption stage, thereby improving overall performance and reliability.

By way of non-limiting example, the valve 20 may selectively switch the flow path of the refrigerant composition and control the flow direction thereof when switching between the cooling mode and the heating mode. The accumulator 50 may temporarily store the refrigerant composition or perform gas-liquid separation and may stabilize the flow of the refrigerant composition into the compressor 60.

In addition, a motor inverter 35 may control driving of the compressor 60 and may adjust a rotational speed and output of the compressor according to required conditions. A PTC heater 80 may act as an auxiliary heating means to provide additional heating when necessary, thereby supplementing heating capacity. A battery 90 may be electrically connected to the system as a power supply device to supply power to the compressor 60, the motor inverter 35, and the PTC heater 80.

In an embodiment, the heat pump may include a compressor, an outdoor heat exchanger, an indoor heat exchanger, an expansion valve, and the above-described heat transfer composition, and may be configured to operate in a heating mode in which the outdoor heat exchanger functions as an evaporator and the indoor heat exchanger functions as a condenser, and in a cooling mode in which the outdoor heat exchanger functions as a condenser and the indoor heat exchanger functions as an evaporator.

In an embodiment, the heat pump may have a coefficient of performance (COP) of 2.0 or greater in a heating mode operated under conditions of an ambient temperature of −20 °C, a condenser temperature of 65 °C, an evaporator temperature of −30 °C, a superheat of 10 °C, and a subcooling of 5 °C.

In an embodiment, the heat transfer composition may have a heat rejection per unit volume of 860 KJ/m³ to 940 kJ/m³ in a heating cycle operated under conditions of a condenser temperature of 65 °C, an evaporator temperature of −30 °C, a superheat of 10 °C, and a subcooling of 5 °C.

In an embodiment, the mixed refrigerant may have a global warming potential (GWP) of 110 or less based on a 100-year time horizon. In an embodiment, a ratio (R) of the total number of F and I atoms to the total number of F, I, and H atoms in the mixed refrigerant may be 0.46 to 0.58, wherein R is defined as R=(F+I)/(F+I+H).

A method of cooling a space using the heat pump according to the present disclosure may include: compressing the heat transfer composition through a compressor; releasing heat in an outdoor heat exchanger functioning as a condenser; expanding the heat transfer composition through an expansion valve; and absorbing heat through an indoor heat exchanger functioning as an evaporator.

A method of heating a space using the heat pump according to the present disclosure may include: compressing the heat transfer composition through a compressor; releasing heat in an indoor heat exchanger functioning as a condenser; expanding the heat transfer composition through an expansion valve; and absorbing heat from an outdoor heat exchanger functioning as an evaporator.

In an embodiment, the method of heating a space using the heat pump may include: compressing the heat transfer composition in a compressor to a high-temperature and high-pressure gaseous state; releasing heat from the compressed heat transfer composition in an indoor heat exchanger functioning as a condenser to heat the space and condensing the heat transfer composition; expanding the condensed heat transfer composition through an expansion valve; and absorbing heat from outdoor air in an outdoor heat exchanger functioning as an evaporator, wherein the heat transfer composition comprises a mixed refrigerant, and the mixed refrigerant comprises, based on a total weight thereof, 7 wt % to 13 wt % of a flammable refrigerant, 18 wt % to 48 wt % of 1,1-difluoroethane (R-152a), 8 wt % to 67 wt % of trans-1,3,3,3-tetrafluoropropene (R-1234ze(E)), and 38 wt % or less of a non-flammable refrigerant, wherein the mixed refrigerant has a boiling point of −33 °C or lower at 1 atm and a latent heat of 217 KJ/kg or greater at −30 °C.

In an embodiment, the space cooling method and the space heating method may be performed in a single heat pump or heat pump system by switching between the cooling mode and the heating mode, such that a heat exchange cycle of the heat transfer composition is achieved. Optionally, a valve configured to selectively switch a flow path of the heat transfer composition and control a flow direction thereof when switching between the cooling mode and the heating mode may be used, and an accumulator configured to temporarily store the heat transfer composition or perform gas-liquid separation and stabilize a state of the heat transfer composition flowing into the compressor may be further used.

As described above, each component illustrated in FIGS. 1 and 2 may operate in conjunction with one another while the heat pump system operates in the cooling mode and the heating mode, such that the heat exchange cycle of the heat transfer composition including the refrigeration oil and the refrigerant may be stably and efficiently performed.

While the foregoing description illustrates a heat pump having a single compressor and a single pair of heat exchangers, the heat pump of the present disclosure is not limited thereto. In an embodiment, the heat pump may include two or more compressors arranged in series. In an embodiment, the heat pump may include an economizer or a vapor injection circuit. In an embodiment, the heat pump may include a cascade configuration. In an embodiment, the heat pump may be a ground-source heat pump

Hereinafter, the embodiments of the present disclosure will be further described with reference to specific experimental examples. The examples and comparative examples included in the experimental examples are merely illustrative of the present disclosure and do not limit the scope of the appended claims.

### EXAMPLES

The components listed in Table 1 below were mixed at their respective contents in a mixing device to prepare heat transfer compositions according to the examples and comparative examples. Each content is expressed as a weight percent (wt %) based on the total weight of the mixed refrigerant. In cases where the heat transfer composition consists of the mixed refrigerant, each content is identical to a weight percent (wt %) based on the total weight of the heat transfer composition.

Equations 1, 1-1, 2, 2-1, and the R values for the heat transfer compositions according to the examples and comparative examples were calculated and are shown together in Table 1.

TABLE 1

| | | | | R1234ze | Equation 1 | Equation 2 | |
|---|---|---|---|---|---|---|---|
| | R32 | R152a | R13I1 | (E) | or 1-1 | or 2-1 | R value |
| Example 1 | 10% | 20% | 17% | 53% | 2.33 | 7.30 | 0.58 |
| Example 2 | 10% | 20% | 18% | 52% | 2.33 | 7.20 | 0.57 |
| Example 3 | 10% | 20% | 19% | 51% | 2.33 | 7.10 | 0.57 |
| Example 4 | 10% | 21% | 16% | 53% | 2.23 | 7.40 | 0.56 |
| Example 5 | 10% | 21% | 17% | 52% | 2.23 | 7.30 | 0.56 |
| Example 6 | 10% | 21% | 18% | 51% | 2.23 | 7.20 | 0.56 |
| Example 7 | 10% | 21% | 19% | 50% | 2.23 | 7.10 | 0.57 |
| Example 8 | 10% | 22% | 16% | 52% | 2.13 | 7.40 | 0.56 |
| Example 9 | 10% | 22% | 17% | 51% | 2.13 | 7.30 | 0.56 |
| Example 10 | 10% | 22% | 18% | 50% | 2.13 | 7.20 | 0.56 |
| Example 11 | 10% | 22% | 19% | 49% | 2.13 | 7.10 | 0.56 |
| Example 12 | 10% | 23% | 16% | 51% | 2.03 | 7.40 | 0.55 |
| Example 13 | 10% | 23% | 17% | 50% | 2.03 | 7.30 | 0.55 |
| Example 14 | 10% | 23% | 18% | 49% | 2.03 | 7.20 | 0.55 |
| Example 15 | 11% | 20% | 16% | 53% | 2.23 | 6.64 | 0.56 |
| Example 16 | 11% | 20% | 17% | 52% | 2.23 | 6.55 | 0.57 |
| Example 17 | 11% | 20% | 18% | 51% | 2.23 | 6.45 | 0.57 |
| Example 18 | 11% | 20% | 19% | 50% | 2.23 | 6.36 | 0.57 |
| Example 19 | 11% | 21% | 16% | 52% | 2.13 | 6.64 | 0.56 |
| Example 20 | 11% | 21% | 17% | 51% | 2.13 | 6.55 | 0.56 |
| Example 21 | 11% | 21% | 18% | 50% | 2.13 | 6.45 | 0.56 |
| Example 22 | 11% | 21% | 19% | 49% | 2.13 | 6.36 | 0.56 |
| Example 23 | 11% | 22% | 16% | 51% | 2.03 | 6.64 | 0.56 |
| Example 24 | 11% | 22% | 17% | 50% | 2.03 | 6.55 | 0.56 |
| Example 25 | 11% | 22% | 18% | 49% | 2.03 | 6.45 | 0.56 |
| Example 26 | 11% | 23% | 16% | 50% | 1.94 | 6.64 | 0.55 |
| Example 27 | 11% | 23% | 17% | 49% | 1.94 | 6.55 | 0.55 |
| Example 28 | 12% | 22% | 16% | 50% | 1.94 | 6.00 | 0.55 |
| Example 29 | 12% | 23% | 16% | 49% | 1.86 | 6.00 | 0.55 |
| Example 30 | 12% | 22% | 17% | 49% | 1.94 | 5.92 | 0.55 |
| Example 31 | 7% | 26% | 25% | 42% | 2.03 | 9.71 | 0.55 |
| Example 32 | 8% | 20% | 15% | 57% | 2.57 | 9.63 | 0.57 |
| Example 33 | 8% | 21% | 15% | 56% | 2.45 | 9.63 | 0.56 |
| Example 34 | 8% | 22% | 15% | 55% | 2.33 | 9.63 | 0.56 |
| Example 35 | 12% | 24% | 0% | 64% | 1.78 | 7.33 | 0.53 |
| Example 36 | 12% | 23% | 0% | 65% | 1.86 | 7.33 | 0.53 |
| Example 37 | 11% | 22% | 0% | 67% | 2.03 | 8.09 | 0.54 |
| Example 38 | 11% | 25% | 6% | 58% | 1.78 | 7.55 | 0.53 |
| Example 39 | 11% | 25% | 7% | 57% | 1.78 | 7.45 | 0.53 |
| Example 40 | 7% | 45% | 36% | 12% | 0.92 | 8.14 | 0.48 |
| Example 41 | 7% | 45% | 37% | 11% | 0.92 | 8.00 | 0.48 |
| Example 42 | 7% | 46% | 37% | 10% | 0.89 | 8.00 | 0.48 |
| Example 43 | 8% | 43% | 27% | 22% | 0.96 | 8.13 | 0.48 |
| Example 44 | 8% | 44% | 27% | 21% | 0.92 | 8.13 | 0.48 |
| Example 45 | 8% | 45% | 28% | 19% | 0.89 | 8.00 | 0.47 |
| Example 46 | 8% | 46% | 28% | 18% | 0.85 | 8.00 | 0.47 |
| Example 47 | 8% | 46% | 29% | 17% | 0.85 | 7.90 | 0.47 |
| Example 48 | 9% | 43% | 29% | 19% | 0.92 | 6.89 | 0.48 |
| Example 49 | 9% | 43% | 30% | 18% | 0.92 | 6.78 | 0.48 |
| Example 50 | 9% | 43% | 31% | 17% | 0.92 | 6.67 | 0.48 |
| Example 51 | 13% | 20% | 7% | 60% | 2.03 | 6.15 | 0.55 |
| Example 52 | 11% | 18% | 20% | 51% | 2.45 | 6.27 | 0.58 |
| Example 53 | 8% | 48% | 36% | 8% | 0.79 | 7.00 | 0.47 |
| Comparative | 20% | 15% | 15% | 50% | 1.86 | 3.25 | 0.56 |
| Example 1 | | | | | | | |
| Comparative | 5% | 40% | 10% | 45% | 1.22 | 17.00 | 0.48 |
| Example 2 | | | | | | | |
| Comparative | 17% | 20% | 5% | 58% | 1.70 | 4.59 | 0.54 |
| Example 3 | | | | | | | |
| Comparative | 5% | 15% | 40% | 40% | 4.00 | 11.00 | 0.60 |
| Example 4 | | | | | | | |
| Comparative | 5% | 5% | 10% | 80% | 9.00 | 17.00 | 0.64 |
| Example 5 | | | | | | | |

The components listed in Table 1 are as follows.
R-32: Difluoromethane
R-152a: 1,1-Difluoroethane
R-1234ze(E): trans-1,3,3,3-Tetrafluoropropene
R-13I1: Trifluoroiodomethane

### Experimental Examples

### Experimental Example 1: Boiling Point at 1 Atm

The boiling point of the mixed refrigerant in each heat transfer composition according to the examples and comparative examples was calculated as a bubble-point temperature under a pressure condition of 1 atm (101.325 kPa) using REFPROP (Version 10.0), a thermodynamic analysis program provided by the National Institute of Standards and Technology (NIST) of the United States.

For each heat transfer composition, the mole fraction, converted based on the weight ratio of the mixed refrigerant composition, was input into REFPROP to calculate the properties of each composition under thermodynamic equilibrium conditions. During the calculation, the effects of pressure loss, heat loss, and non-ideal flow were ignored. This approach was applied equally to Experimental Examples 2 and 3.

### Experimental Example 2: Latent Heat at −30 °C

The latent heat of the mixed refrigerant in each heat transfer composition according to the examples and comparative examples was calculated using REFPROP (Version 10.0) provided by the National Institute of Standards and Technology (NIST), based on saturated conditions at −30 °C. The latent heat was calculated as a difference between the enthalpy of a saturated vapor state and the enthalpy of a saturated liquid state at −30 °C.

### Experimental Example 3: Temperature Glide at 1.5 Bar

The temperature glide of the mixed refrigerant in each heat transfer composition according to the above-described examples and comparative examples was calculated using REFPROP (Version 10.0) provided by the National Institute of Standards and Technology (NIST) under constant-pressure conditions of 1.5 bar. The temperature glide was defined as a difference between the dew point temperature and the bubble point temperature at a pressure of 1.5 bar under thermodynamic equilibrium conditions.

### Experimental Example 4: Global Warming Potentials (GWP)

For 1,1-difluoroethane, trifluoroiodomethane, and trans-1,3,3,3-tetrafluoropropene included in the mixed refrigerant in each heat transfer composition according to the examples and comparative examples, the respective Global Warming Potential (GWP) values were applied based on a 100-year time horizon (Global Warming Potential over a 100-year time horizon) as presented by the Intergovernmental Panel on Climate Change (IPCC). In this specification, the values set forth in the IPCC Fourth Assessment Report (AR4) were used as the reference.

The GWP of the mixed refrigerant in the heat transfer composition was calculated as a weighted arithmetic mean of the GWP values of each component based on the weight ratio of each component as described above.

### Experimental Example 5: Acute Toxicity Exposure Limit (ATEL)

The ATEL for the mixed refrigerant in each heat transfer composition according to the above-described examples and comparative examples was calculated based on toxicity data for each component, such as LC₅₀ (inhalation), and by applying an appropriate safety factor according to ASHRAE Standard 34. The ATEL is defined as a concentration considered non-hazardous to humans when inhaled over a short period of time (typically within 1 hour) and is expressed in units of ppm.

Acute toxicity classification as a safety class was conducted according to ISO 817 and ASHRAE Standard 34, “Designation and Safety Classification of Refrigerants.” The toxicity class was determined based on the lowest value among the lethal concentration (LC₅₀), cardiac sensitization value, and anesthesia value for each component. If the lowest value was 10,000 ppm or more, it was classified as a low-toxicity class, and if it was less than 10,000 ppm, it was classified as a high-toxicity class.

For 1,1-difluoroethane, trifluoroiodomethane, and trans-1,3,3,3-tetrafluoropropene included in each heat transfer composition according to the examples and comparative examples, toxicity classes were classified for each component according to the above-described criteria, and ATEL values were calculated separately.

The ATEL of the mixed refrigerant in the heat transfer composition was calculated using a weighted harmonic mean method based on the mole fraction of each component. The overall ATEL value was calculated to reflect the influence of the most toxic component (i.e., the component with the lowest ATEL value) in the composition.

According to this criterion, if the overall ATEL was 10,000 ppm or more, it was marked with “o”, and if it was less than 10,000 ppm, it was marked with “X.”

### Experimental Example 6: Flammability Evaluation

The flammability evaluation was conducted for the mixed refrigerant in each heat transfer composition according to the above-described examples, as follows.

### (1) Lower Flammability Limit (LFL) Evaluation

The LFL of each heat transfer composition (mixed refrigerant) was evaluated according to ASTM E681. A flask with a volume of 12 L was used, and the ignition source was positioned at approximately one-third of the flask height. Considering the temperature dependence of the lower flammability limit, tests were conducted under atmospheric pressure at a room temperature of 23 °C and under atmospheric pressure at a high temperature of 60 °C, respectively. Humid air having a relative humidity of 50% was used.

Under each test condition, the mixture ratio of the mixed refrigerant and air was varied in a stepwise manner, and ignition was observed. The minimum concentration at which ignition occurred was defined as the lower flammability limit. The above-described lower flammability limit evaluation was conducted by applying criteria according to ISO 817 and ASHRAE Standard 34.

In the present disclosure, when the lower flammability limit exceeded 0.1 kg/m³, the flammability risk was considered to be relatively low, and the composition was evaluated as a pass (“⊚”).

### (2) Burning Velocity Evaluation

The burning velocity of each heat transfer composition (mixed refrigerant) was evaluated according to ISO 817. A cylindrical tube having an inner diameter of 40 mm was used, and the ignition source was positioned at a lower end of the cylinder. The test was conducted under dry air at atmospheric pressure of 23 °C.

After the mixed refrigerant and air mixture was ignited, the flame propagation velocity within the cylinder was measured to calculate the burning velocity. The above-described burning velocity evaluation was conducted by applying criteria according to ISO 817 and ASHRAE Standard 34.

In the present disclosure, when the burning velocity was 10 cm/s or less, the flammability risk was considered to be relatively low, and the composition was evaluated as excellent (“@”). When the burning velocity exceeded 10 cm/s, the composition was evaluated as moderate (“ ”).

### Experimental Example 7: Heating Evaluation

FIG. 2 is a schematic view illustrating the flow of the heat transfer composition for heat exchange in a heating mode of a heat exchanger according to an embodiment of the present disclosure.

Referring to FIG. 2, in the heating mode, the heat transfer composition (hereinafter also referred to as the mixed refrigerant) may be compressed by a compressor, may then release heat in an indoor heat exchanger (indoor heat exchanger), may be expanded while passing through an expansion valve (heating), thereby being converted to a low-temperature and low-pressure state, and may absorb external heat in an outdoor heat exchanger (which functions as an evaporator in the heating mode). Thereafter, the heat transfer composition may return to the compressor, thereby repeating the above-described circulation cycle.

Under these conditions, to evaluate the heating characteristics of each heat transfer composition according to the above-described examples and comparative examples, a volumetric heating capacity and a coefficient of performance (COP) of the heat pump were evaluated.

The evaluation was conducted using NIST CYCLE_D, a thermodynamic cycle analysis program provided by the National Institute of Standards and Technology (NIST), and heating-mode conditions such as an ambient temperature, an evaporator temperature, a condenser temperature, a degree of superheat, and a degree of subcooling listed in Table 2 below were applied as input parameters.

TABLE 2

| | Air | | | | | | |
|---|---|---|---|---|---|---|---|
| | conditioning | | | | | | |
| Ambient | system outlet | Evaporator | Condenser | | | Compressor | |
| temperature | temperature | temperature | Temperature | Superheat | Subcooling | efficiency | |
| (°C) | (°C) | (°C) | (°C) | (°C) | (°C) | Isentropic | Volumetric |
| −20 | 55 | −30 | 65 | 10 | 5 | 0.7 | 0.95 |

### (1) Coefficient of Performance (COP) of the Heat Pump

The coefficient of performance (COP) of the heat pump was calculated using CYCLE_D, a cycle analysis program provided by the National Institute of Standards and Technology (NIST).

The CYCLE_D program may predict the thermodynamic performance of a standard refrigerant cycle consisting of an evaporator, a compressor, a condenser, and an expansion valve. Based on the operating conditions input by a user, the state points (pressure, temperature, enthalpy, entropy, etc.) of the mixed refrigerant were calculated, and the COP, which is a performance indicator for the entire mixed refrigerant cycle, was automatically determined. For specific operating conditions, reference is made to Table 2 above.

The heat release (Q_{cond}) and the compressor energy consumption (Q_{comp}) during the condensation process of the mixed refrigerant were calculated using the CYCLE_D program, and the calculated values were substituted into Equation 3 below to calculate the COP:

COP=Q_{cond}/Q_{comp} [Equation 3]

### Volumetric Heating Capacity

Based on the heating cycle conditions listed in Table 2 above, among thermodynamic state variables of the mixed refrigerant, the specific volume was calculated using REFPROP (Version 10.0), a thermodynamic analysis program provided by the National Institute of Standards and Technology (NIST).

The heating capacity (P) and the volumetric efficiency (C) of the compressor were calculated using CYCLE_D, a zero-dimensional (OD) cycle analysis program provided by NIST.

The volumetric heating capacity (V) was calculated according to Equation 4 below:

Volumetric heating capacity(V)=P×C×D [Equation 4]

In Equation 4, P is the amount of heat released from the condenser (heating capacity), C is the volumetric efficiency of the compressor, and D is the density of the mixed refrigerant at the compressor inlet (the reciprocal of the specific volume).

The results of the experimental examples are shown in Tables 3 through 5 below.

TABLE 3

| | | | | | Boiling | |
|---|---|---|---|---|---|---|
| | | | | | point | Latent |
| | | | | R1234ze | (degrees | heat |
| | R32 | R152a | R13I1 | (E) | C) | (kJ/kg) |
| Example 1 | 10% | 20% | 17% | 53% | −35 | 222 |
| Example 2 | 10% | 20% | 18% | 52% | −35.1 | 221 |
| Example 3 | 10% | 20% | 19% | 51% | −35.2 | 220 |
| Example 4 | 10% | 21% | 16% | 53% | −34.8 | 224 |
| Example 5 | 10% | 21% | 17% | 52% | −34.9 | 223 |
| Example 6 | 10% | 21% | 18% | 51% | −35 | 222 |
| Example 7 | 10% | 21% | 19% | 50% | −35.1 | 221 |
| Example 8 | 10% | 22% | 16% | 52% | −34.7 | 226 |
| Example 9 | 10% | 22% | 17% | 51% | −34.8 | 225 |
| Example 10 | 10% | 22% | 18% | 50% | −34.9 | 224 |
| Example 11 | 10% | 22% | 19% | 49% | −35.1 | 223 |
| Example 12 | 10% | 23% | 16% | 51% | −34.7 | 227 |
| Example 13 | 10% | 23% | 17% | 50% | −34.8 | 226 |
| Example 14 | 10% | 23% | 18% | 49% | −34.9 | 225 |
| Example 15 | 11% | 20% | 16% | 53% | −35.6 | 224 |
| Example 16 | 11% | 20% | 17% | 52% | −35.7 | 223 |
| Example 17 | 11% | 20% | 18% | 51% | −35.8 | 222 |
| Example 18 | 11% | 20% | 19% | 50% | −35.9 | 221 |
| Example 19 | 11% | 21% | 16% | 52% | −35.5 | 226 |
| Example 20 | 11% | 21% | 17% | 51% | −35.6 | 225 |
| Example 21 | 11% | 21% | 18% | 50% | −35.7 | 224 |
| Example 22 | 11% | 21% | 19% | 49% | −35.8 | 223 |
| Example 23 | 11% | 22% | 16% | 51% | −35.4 | 227 |
| Example 24 | 11% | 22% | 17% | 50% | −35.5 | 226 |
| Example 25 | 11% | 22% | 18% | 49% | −35.7 | 225 |
| Example 26 | 11% | 23% | 16% | 50% | −35.4 | 229 |
| Example 27 | 11% | 23% | 17% | 49% | −35.5 | 227 |
| Example 28 | 12% | 22% | 16% | 50% | −36.1 | 229 |
| Example 29 | 12% | 23% | 16% | 49% | −36 | 230 |
| Example 30 | 12% | 22% | 17% | 49% | −36.2 | 228 |
| Example 31 | 7% | 26% | 25% | 42% | −33 | 218 |
| Example 32 | 8% | 20% | 15% | 57% | −33.2 | 221 |
| Example 33 | 8% | 21% | 15% | 56% | −33.1 | 223 |
| Example 34 | 8% | 22% | 15% | 55% | −33 | 224 |
| Example 35 | 12% | 24% | 0% | 64% | −34.1 | 248 |
| Example 36 | 12% | 23% | 0% | 65% | −34.2 | 247 |
| Example 37 | 11% | 22% | 0% | 67% | −33.6 | 244 |
| Example 38 | 11% | 25% | 6% | 58% | −34.1 | 242 |
| Example 39 | 11% | 25% | 7% | 57% | −34.2 | 241 |
| Example 40 | 7% | 45% | 36% | 12% | −33.1 | 231 |
| Example 41 | 7% | 45% | 37% | 11% | −33 | 233 |
| Example 42 | 7% | 46% | 37% | 10% | −33.1 | 240 |
| Example 43 | 8% | 43% | 27% | 22% | −33 | 242 |
| Example 44 | 8% | 44% | 27% | 21% | −33.1 | 242 |
| Example 45 | 8% | 45% | 28% | 19% | −33 | 243 |
| Example 46 | 8% | 46% | 28% | 18% | −33.1 | 242 |
| Example 47 | 8% | 46% | 29% | 17% | −33 | 232 |
| Example 48 | 9% | 43% | 29% | 19% | −34 | 240 |
| Example 49 | 9% | 43% | 30% | 18% | −34 | 239 |
| Example 50 | 9% | 43% | 31% | 17% | −34.1 | 238 |
| Example 51 | 13% | 20% | 7% | 60% | −33 | 225 |
| Example 52 | 11% | 18% | 20% | 51% | −36.2 | 218 |
| Example 53 | 8% | 48% | 36% | 8% | −33.6 | 238 |
| Comparative | 20% | 15% | 15% | 50% | −40.7 | 232 |
| Example 1 | | | | | | |
| Comparative | 5% | 40% | 10% | 45% | −29.1 | 249 |
| Example 2 | | | | | | |
| Comparative | 17% | 20% | 5% | 58% | −37.8 | 245 |
| Example 3 | | | | | | |
| Comparative | 5% | 15% | 40% | 40% | −33.2 | 185 |
| Example 4 | | | | | | |
| Comparative | 5% | 5% | 10% | 80% | −30.2 | 203 |
| Example 5 | | | | | | |

TABLE 4

| | Glide | | | Heat rejection | |
|---|---|---|---|---|---|
| | (°C) | GWP | ATEL | per unit volume | COP |
| Example 1 | 8.1 | 93 | ◯ | 887 | 2.05 |
| Example 2 | 8.1 | 93 | ◯ | 891 | 2.05 |
| Example 3 | 8.1 | 93 | ◯ | 896 | 2.05 |
| Example 4 | 8 | 94 | ◯ | 885 | 2.05 |
| Example 5 | 8 | 94 | ◯ | 890 | 2.05 |
| Example 6 | 8 | 94 | ◯ | 894 | 2.06 |
| Example 7 | 8 | 94 | ◯ | 898 | 2.06 |
| Example 8 | 7.9 | 95 | ◯ | 888 | 2.06 |
| Example 9 | 7.9 | 95 | ◯ | 892 | 2.06 |
| Example 10 | 7.9 | 95 | ◯ | 897 | 2.06 |
| Example 11 | 7.9 | 95 | ◯ | 901 | 2.06 |
| Example 12 | 7.7 | 97 | ◯ | 891 | 2.06 |
| Example 13 | 7.8 | 97 | ◯ | 895 | 2.06 |
| Example 14 | 7.8 | 97 | ◯ | 899 | 2.06 |
| Example 15 | 8.4 | 100 | ◯ | 903 | 2.05 |
| Example 16 | 8.5 | 100 | ◯ | 907 | 2.05 |
| Example 17 | 8.5 | 100 | ◯ | 912 | 2.05 |
| Example 18 | 8.5 | 100 | ◯ | 916 | 2.05 |
| Example 19 | 8.3 | 101 | ◯ | 905 | 2.05 |
| Example 20 | 8.3 | 101 | ◯ | 910 | 2.06 |
| Example 21 | 8.3 | 101 | ◯ | 914 | 2.06 |
| Example 22 | 8.4 | 101 | ◯ | 919 | 2.06 |
| Example 23 | 8.2 | 102 | ◯ | 908 | 2.06 |
| Example 24 | 8.2 | 102 | ◯ | 912 | 2.06 |
| Example 25 | 8.2 | 102 | ◯ | 917 | 2.06 |
| Example 26 | 8.1 | 103 | ◯ | 910 | 2.06 |
| Example 27 | 8.1 | 103 | ◯ | 915 | 2.06 |
| Example 28 | 8.5 | 109 | ◯ | 928 | 2.06 |
| Example 29 | 8.4 | 110 | ◯ | 930 | 2.06 |
| Example 30 | 8.5 | 109 | ◯ | 933 | 2.06 |
| Example 31 | 6.3 | 80 | ◯ | 875 | 2.07 |
| Example 32 | 7.2 | 80 | ◯ | 839 | 2.05 |
| Example 33 | 7.1 | 81 | ◯ | 842 | 2.05 |
| Example 34 | 7 | 82 | ◯ | 845 | 2.05 |
| Example 35 | 8 | 111 | ◯ | 865 | 2.06 |
| Example 36 | 8.1 | 110 | ◯ | 863 | 2.05 |
| Example 37 | 7.9 | 102 | ◯ | 843 | 2.05 |
| Example 38 | 7.7 | 106 | ◯ | 874 | 2.06 |
| Example 39 | 7.7 | 106 | ◯ | 878 | 2.06 |
| Example 40 | 5 | 104 | ◯ | 959 | 2.11 |
| Example 41 | 5 | 105 | ◯ | 963 | 2.11 |
| Example 42 | 5.5 | 108 | ◯ | 965 | 2.11 |
| Example 43 | 5.5 | 109 | ◯ | 938 | 2.1 |
| Example 44 | 5.4 | 110 | ◯ | 940 | 2.1 |
| Example 45 | 5.4 | 112 | ◯ | 945 | 2.11 |
| Example 46 | 5.4 | 112 | ◯ | 947 | 2.11 |
| Example 47 | 5 | 104 | ◯ | 951 | 2.11 |
| Example 48 | 5.9 | 115 | ◯ | 966 | 2.1 |
| Example 49 | 5.9 | 115 | ◯ | 970 | 2.1 |
| Example 50 | 5.9 | 115 | ◯ | 974 | 2.1 |
| Example 51 | 9 | 115 | ◯ | 892 | 2.06 |
| Example 52 | 8.7 | 97 | ◯ | 915 | 2.05 |
| Example 53 | 5.3 | 114 | ◯ | 983 | 2.12 |
| Comparative | 10.6 | 154 | ◯ | 1076 | 2.05 |
| Example 1 | | | | | |
| Comparative | 4 | 84 | ◯ | 818 | 2.09 |
| Example 2 | | | | | |
| Comparative | 9.7 | 140 | ◯ | 970 | 2.05 |
| Example 3 | | | | | |
| Comparative | 6.4 | 53 | X | 858 | 2.06 |
| Example 4 | | | | | |
| Comparative | 7.2 | 41 | ◯ | 703 | 2.01 |
| Example 5 | | | | | |

TABLE 5

| | Equation 1-1 | LFL | Burning velocity |
|---|---|---|---|
| Example 1 | 2.33 | ⊚ | ⊚ |
| Example 2 | 2.33 | ⊚ | ⊚ |
| Example 3 | 2.33 | ⊚ | ⊚ |
| Example 4 | 2.23 | ⊚ | ⊚ |
| Example 5 | 2.23 | ⊚ | ⊚ |
| Example 6 | 2.23 | ⊚ | ⊚ |
| Example 7 | 2.23 | ⊚ | ⊚ |
| Example 8 | 2.13 | ⊚ | ⊚ |
| Example 9 | 2.13 | ⊚ | ⊚ |
| Example 10 | 2.13 | ⊚ | ⊚ |
| Example 11 | 2.13 | ⊚ | ⊚ |
| Example 12 | 2.03 | ⊚ | ⊚ |
| Example 13 | 2.03 | ⊚ | ⊚ |
| Example 14 | 2.03 | ⊚ | ⊚ |
| Example 15 | 2.23 | ⊚ | ⊚ |
| Example 16 | 2.23 | ⊚ | ⊚ |
| Example 17 | 2.23 | ⊚ | ⊚ |
| Example 18 | 2.23 | ⊚ | ⊚ |
| Example 19 | 2.13 | ⊚ | ⊚ |
| Example 20 | 2.13 | ⊚ | ⊚ |
| Example 21 | 2.13 | ⊚ | ⊚ |
| Example 22 | 2.13 | ⊚ | ⊚ |
| Example 23 | 2.03 | ⊚ | ⊚ |
| Example 24 | 2.03 | ⊚ | ⊚ |
| Example 25 | 2.03 | ⊚ | ⊚ |
| Example 26 | 1.94 | ⊚ | ⊚ |
| Example 27 | 1.94 | ⊚ | ⊚ |
| Example 28 | 1.94 | ⊚ | ⊚ |
| Example 29 | 1.86 | ⊚ | ⊚ |
| Example 30 | 1.94 | ⊚ | ⊚ |
| Example 31 | 2.03 | ⊚ | ⊚ |
| Example 32 | 2.57 | ⊚ | ⊚ |
| Example 33 | 2.45 | ⊚ | ⊚ |
| Example 34 | 2.33 | ⊚ | ⊚ |
| Example 35 | 1.78 | ⊚ | ⊚ |
| Example 36 | 1.86 | ⊚ | ⊚ |
| Example 37 | 2.03 | ⊚ | ⊚ |
| Example 38 | 1.78 | ⊚ | ⊚ |
| Example 39 | 1.78 | ⊚ | ⊚ |
| Example 40 | 0.92 | ⊚ | ◯ |
| Example 41 | 0.92 | ⊚ | ◯ |
| Example 42 | 0.89 | ⊚ | ◯ |
| Example 43 | 0.96 | ⊚ | ◯ |
| Example 44 | 0.92 | ⊚ | ◯ |
| Example 45 | 0.89 | ⊚ | ◯ |
| Example 46 | 0.85 | ⊚ | ◯ |
| Example 47 | 0.85 | ⊚ | ◯ |
| Example 48 | 0.92 | ⊚ | ◯ |
| Example 49 | 0.92 | ⊚ | ◯ |
| Example 50 | 0.92 | ⊚ | ◯ |
| Example 51 | 2.03 | ⊚ | ⊚ |
| Example 52 | 2.45 | ⊚ | ⊚ |
| Example 53 | 0.79 | ⊚ | ◯ |

Referring to Tables 3 and 4, in the heat transfer compositions according to the examples, the mixed refrigerant exhibited a boiling point at 1 atm of −33 °C or lower, and a latent heat at −30 °C controlled to be 217 KJ/kg or more. Accordingly, sufficient heat transfer could be achieved even under low-pressure conditions, enabling effective heat transport under low-temperature heating conditions.

In particular, for the heat transfer compositions of Examples 1 to 34 and 38 to 53, which included a mixed refrigerant composed of difluoromethane (R-32), 1,1-difluoroethane (R-152a), and trans-1,3,3,3-tetrafluoropropene (R-1234ze(E)) as flammable refrigerants, and trifluoroiodomethane (R-1311) as a non-flammable refrigerant, and which satisfied the relationship of Equation 1:0.85≤(W3+W4)/(W1+W2), the latent heat of the mixed refrigerant at −30 °C was controlled within a range of 218 kJ/kg to 245 KJ/kg. As a result, the same heating performance could be secured while reducing the compressor flow rate, thereby improving the output density and energy efficiency of the system. Said differently, Examples 1 to 34 and 38 to 53 included a mixed refrigerant composed of difluoromethane (R-32) as the flammable refrigerant other than R-152a and R-1234ze(E), 1,1-difluoroethane (R-152a), trans-1,3,3,3-tetrafluoropropene (R-1234ze(E)), and trifluoroiodomethane (R-13I1) as the non-flammable refrigerant. These compositions satisfied the relationship of Equation 1:0.85≤(W3+W4)/(W1+W2), where W1-W4 are as defined herein. For these examples, the latent heat of the mixed refrigerant at −30 °C was controlled within a range of 218 KJ/kg to 245 KJ/kg.

In Examples 1 to 34, 38, 39, 51, and 52, which satisfied the relationship of Equation 1-1:1.7≤(W3+W4)/(W1+W2)≤3.9, the mixed refrigerant exhibited a boiling point at 1 atm in a range of −37 °C to −33 °C, a temperature glide at a pressure of 1.5 bar in a range of 6.0 °C to 9.0 °C, and a heat rejection per unit volume of the heat transfer composition secured at 839 kJ/m³ or more, thereby enabling stable operation even under low-temperature environmental conditions. Accordingly, the heat transfer composition exhibited enhanced heat transport performance per unit volume, and a relatively small variation in saturation temperature, which contributed to improved heat exchanger efficiency and enhanced precision in system control. Furthermore, the heat transfer compositions of Examples 1 to 34, 38, 39, 51, and 52 passed the lower flammability limit (LFL) evaluation and were all evaluated as excellent in the burning velocity evaluation, indicating that flammability was effectively suppressed and flammability safety was further improved.

In Examples 1 to 30, 35, 36, 38, 39, 48 to 50, and 52, which satisfied the relationship of Equation 2: (W2+W4)/W1<7.6, the boiling point of the mixed refrigerant at 1 atm was controlled to −34 °C or lower. As a result, evaporation of the mixed refrigerant proceeded smoothly even under environments with very low ambient temperatures, thereby effectively improving heating performance under low-temperature conditions.

In addition, these examples also satisfied the relationship of Equation 2-1:5≤(W2+W4)/W1<7.6, such that the boiling point of the mixed refrigerant at 1 atm was in a range of −37 °C to −34 °C, and the heat rejection per unit volume of the heat transfer composition was controlled to 860 KJ/m³ or more. Accordingly, the circulation amount of the mixed refrigerant and the compressor volumetric flow rate required to achieve the same heating performance could be reduced. As a result, the compressor size and the overall system volume could be reduced, thereby improving the overall efficiency of the system.

The heat transfer composition of Example 51 contained a higher amount of difluoromethane (R-32) than the other examples. As a result, the mixed refrigerant exhibited a relatively higher boiling point and a relatively higher temperature glide.

In Example 53, the content of trifluoroiodomethane (R-1311) was higher and the content of trans-1,3,3,3-tetrafluoropropene (R-1234ze(E)) was lower than those of the other examples. Accordingly, the boiling point was relatively high, while the temperature glide was relatively low.

In Examples 35 and 36, which did not include R-1311, the latent heat of the mixed refrigerant at −30 °C was confirmed to exceed 245 KJ/kg. In particular, Example 35 exhibited a relatively high global warming potential (GWP) of 111.

Furthermore, in the case of Example 37, which also did not include R-1311, the boiling point of the mixed refrigerant at 1 atm was relatively high at −33.6 °C, and the heat rejection per unit volume was also relatively low, being less than 845 KJ/m³.

The heat transfer compositions according to Comparative Examples 1 to 5 contained component contents that were either excessively low or excessively high. As a result, one or more of the boiling point of the mixed refrigerant at 1 atm, the latent heat at −30 °C, the temperature glide at a pressure of 1.5 bar, and the heat rejection per unit volume of the compositions were deteriorated. Accordingly, the heat transfer compositions of the comparative examples having such properties may readily suffer from problems such as a reduction in evaporation pressure, degradation of heat exchanger efficiency, a decrease in power density, and reduced energy efficiency during low-temperature operation.

In Comparative Examples 1 and 3, the resulting values of the relationships represented by Equation 2 or Equation 2-1 were relatively low, at 3.3 and 4.6, respectively, which were less than 5. In contrast, in Comparative Examples 2, 4, and 5, the resulting values were 17, 11, and 17, respectively, which significantly exceeded 7.6.

In Comparative Examples 1 and 3, the temperature glide of the mixed refrigerant at a pressure of 1.5 bar was excessively high, which could readily degrade heat exchanger efficiency and system control stability. In addition, the global warming potential (GWP) was significantly high, such that, in the event of leakage, the impact on climate change could be substantial, and use thereof could be restricted or prohibited in view of environmental regulations. In particular, in Comparative Example 1, the boiling point of the mixed refrigerant at 1 atm was excessively low, which could lead to problems such as reduced compressor operating stability, increased load on the condenser, and difficulties in handling the mixed refrigerant.

In Comparative Examples 2 and 5, the boiling point of the mixed refrigerant at 1 atm and the heat rejection per unit volume of the heat transfer composition were relatively low. As a result, the evaporation pressure could become excessively low, leading to unstable low-temperature operation. Furthermore, insufficient heat transport per unit volume could readily cause a reduction in power density and system efficiency. In Comparative Example 5, the COP was also significantly deteriorated. In addition, in Comparative Example 2, the temperature glide of the mixed refrigerant at a pressure of 1.5 bar was excessively low.

In Comparative Examples 4 and 5, the latent heat of the mixed refrigerant at −30 °C was excessively low, which could readily cause problems such as an increased flow rate in the compressor, reduced power density, and deterioration of system energy efficiency. In Comparative Example 4, the acute toxicity exposure limit (ATEL) was evaluated as “X,” indicating a high risk of toxicity to humans and a low safety classification. Accordingly, the heat transfer composition of Comparative Example 4, having the above-described properties, may be subject to restrictions on use or may be disadvantageous in satisfying environmental and safety certification requirements.

What is claimed is:

1. A heat transfer composition comprising a mixed refrigerant including, based on the total weight of the mixed refrigerant, 7% by weight to 13% by weight of a flammable refrigerant, 18% by weight to 48% by weight of 1,1-difluoroethane (R-152a), 8% by weight to 67% by weight of trans-1,3,3,3-tetrafluoropropene (R-1234ze(E)), and 38% by weight or less of a non-flammable refrigerant,
wherein the mixed refrigerant has a boiling point at 1 atm of −33 degrees C or lower, and a latent heat at −30 degrees C of 217 KJ/kg or more.

2. The heat transfer composition according to claim 1, wherein the heat transfer composition has a heat rejection per unit volume of greater than 837 KJ/m³ in a heating cycle operated under conditions of a condenser temperature of 65 degrees C, an evaporator temperature of −30 degrees C, a superheat of 10 degrees C, and a subcooling of 5 degrees C.

3. The heat transfer composition according to claim 1, wherein the mixed refrigerant has a temperature glide of less than 9 degrees C at a pressure of 1.5 bar.

4. The heat transfer composition according to claim 1, wherein the mixed refrigerant does not include 2,3,3,3-tetrafluoropropene (R-1234yf).

5. The heat transfer composition according to claim 1, wherein the heat transfer composition satisfies Equation 1 below:
0.85 (less than or equal to) (W3+W4)/(W1+W2) [Equation 1]
in Equation 1, W1 represents a content of the flammable refrigerant, W2 represents a content of 1,1-difluoroethane (R-152a), W3 represents a content of the non-flammable refrigerant, and W4 represents a content of trans-1,3,3,3-tetrafluoropropene (R-1234ze(E)), and each content is expressed in a weight percent (wt %) relative to the total weight of the mixed refrigerant.

6. The heat transfer composition according to claim 5, wherein the heat transfer composition satisfies Equation 1-1 below:
1.7 (less than or equal to) (W3+W4)/(W1+W2) (less than or equal to) 3.9 [Equation 1-1]
in Equation 1-1, W1 represents the content of the flammable refrigerant, W2 represents the content of 1,1-difluoroethane (R-152a), W3 represents the content of the non-flammable refrigerant, and W4 represents the content of trans-1,3,3,3-tetrafluoropropene (R-1234ze(E)), and each content is expressed in a weight percent (wt %) relative to the total weight of the mixed refrigerant.

7. The heat transfer composition according to claim 6, wherein the temperature glide of the mixed refrigerant at a pressure of 1.5 bar is 6.0 degrees C to 8.9 degrees C.

8. The heat transfer composition according to claim 1, wherein the heat transfer composition satisfies Equation 2 below:
(W2+W4)/W1<7.6 [Equation 2]
in Equation 2, W1 represents a content of the flammable refrigerant, W2 represents a content of 1,1-difluoroethane (R-152a), and W4 represents a content of trans-1,3,3,3-tetrafluoropropene (R-1234ze(E)), and each content is expressed in a weight percent (wt %) relative to the total weight of the mixed refrigerant.

9. The heat transfer composition according to claim 8, wherein the boiling point of the mixed refrigerant at 1 atm is −34 degrees C or lower.

10. The heat transfer composition according to claim 8, wherein the heat transfer composition satisfies Equation 2-1 below:
5 (less than or equal to) (W2+W4)/W1<7.6 [Equation 2-1]
in Equation 2-1, W1 represents the content of the flammable refrigerant, W2 represents the content of 1,1-difluoroethane (R-152a), and W4 represents the content of trans-1,3,3,3-tetrafluoropropene (R-1234ze(E)), and each content is expressed in a weight percent (wt %) relative to the total weight of the mixed refrigerant.

11. The heat transfer composition according to claim 2, wherein the latent heat of the mixed refrigerant at −30 degrees C is 220 KJ/kg to 250 KJ/kg.

12. The heat transfer composition according to claim 1, wherein a total content of 1,1-difluoroethane (R-152a) and trans-1,3,3,3-tetrafluoropropene (R-1234ze(E)) is 55% by weight to 90% by weight, based on the total weight of the mixed refrigerant.

13. The heat transfer composition according to claim 1, wherein a total content of the non-flammable refrigerant and trans-1,3,3,3-tetrafluoropropene (R-1234ze(E)) is 60% by weight to 75% by weight, based on the total weight of the mixed refrigerant.

14. The heat transfer composition according to claim 1, wherein the heat transfer composition includes the flammable refrigerant in an amount of 8% by weight to 12% by weight, based on the total weight of the mixed refrigerant.

15. The heat transfer composition according to claim 1, wherein the heat transfer composition includes 1,1-difluoroethane (R-152a) in an amount of 20% by weight to 23% by weight, based on the total weight of the mixed refrigerant.

16. The heat transfer composition according to claim 1, wherein the heat transfer composition includes trans-1,3,3,3-tetrafluoropropene (R-1234ze(E)) in an amount of 49% by weight to 53% by weight, based on the total weight of the mixed refrigerant.

17. The heat transfer composition according to claim 1, wherein the heat transfer composition includes the non-flammable refrigerant in an amount of 16% by weight to 19% by weight, based on the total weight of the mixed refrigerant.

18. The heat transfer composition according to claim 1, wherein a ratio (R) of the total number of F and I atoms to the total number of F, I, and H atoms included in the mixed refrigerant is 0.46 to 0.58, wherein R=(F+I)/(F+I+H).

19. The heat transfer composition according to claim 1, wherein the heat transfer composition further comprises at least one of a base oil and an additive.

20. A heat pump comprising the heat transfer composition according to claim 1.
